(19) United States
(12) Patent Application Publication
(10) Pub. No.: US 2022/0385754 A1
(43) Pub. Date: Dec. 1, 2022

(54) Fast Remote Stage Applications

(71) Applicant: Production Resource Group, L.L.C., New Windsor, NY (US)

(72) Inventor: Christopher D. Conti, Rutherford, NJ (US)

(21) Appl. No.: 17/804,868

(22) Filed: Jun. 1, 2022

Related U.S. Application Data
(60) Provisional application No. 63/202,209, filed on Jun. 1, 2021.

(51) Int. Cl. H04M 1/72409; G06F 3/14; G09G 3/32

(52) U.S. Cl. CPC H04M 1/72409; G06F 3/1446; G09G 3/32; G09G 2300/026; G09G 2370/042; G09G 2370/16

(57) ABSTRACT

Fast wireless communicators are used to carry out functions in a stage lighting display environment. LED tiles can be equipped with fast Internet such as 5G, and each of a number of LED tiles in an array can define an address that represents a part of the array. The video processor can break up an image into different parts for each LED tile of the array and send those different parts to the array.

This application Claims priority from Provisional Application No. 63/202,209, filed Jun. 1, 2021, the entire contents of which are herewith incorporated by reference.

### BACKGROUND

Typical stage lighting and stage multimedia presentations involve an operator who is controlling aspects of the presentation from an area local to the stage. For example, a conventional stage lighting system uses a console, that is local to the stage, and operated by an operator who is near the stage.

### SUMMARY

It has become desirable to carry out many different kinds of operations remotely.

The inventor recognizes that technologies such as 5G can allow this kind of remote control, faster operation.

The present application describes applications which rely on fast technology such as 5G to change the basic nature of certain kinds of stage lighting technology by allowing new forms and aspects of remote control.

### BRIEF DESCRIPTION OF THE DRAWINGS

the drawings show aspects of the invention, and specifically:

FIG. 1 shows an embodiment of wirelessly controlling an LED wall made up of a number of LED tiles; and

FIG. 2 shows a retrofit card used to retrofit a legacy style stage lighting device, to allow monitor and startup of the light.

### DETAILED DESCRIPTION

The following provides aspects that can be used with fast network applications to allow certain operations to be done much more efficiently. The fast network connection can be 5G according to one embodiment, but can also be other wireless communication systems.

A first embodiment describes remote control of video walls formed of LED tiles. Video walls have been used to create and display video imagery and content at theatrical events such as concerts. These walls are typically built from multiple individual tiles. Each tile is separately controllable. Each tile has required a power cable and a data cable that delivers a video image to the tile from a video processor. The video processor takes a standard video signal such as SDI or HDMI from a video source, breaks up the imagery into multiple different tiles, and supplies the content as smaller chunks to a specific tile over the data cable.

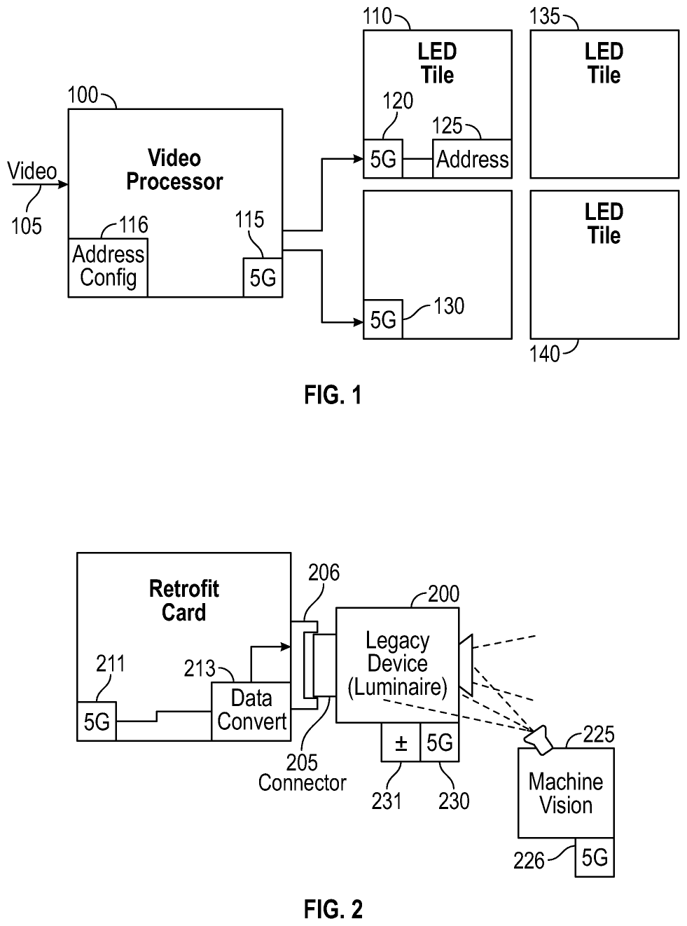

According to an embodiment, shown in FIG. 1, the video processor 100 receives video information 105. As conventional, the video processor divides this video into individual chunks, each chunk intended for one LED tile. The information is sent using the 5G card 115. In an alternative embodiment, the information can be set over conventional Wi-Fi or wired Internet. The LED tiles such as 110 each receive one chunk of the video. The video processor includes a fast Internet wireless device such as a 5G card 120. The LED tile includes an address setting part 125 which defines its address. This may be a processor, or a controller, or can be part of the billing-identifying structure such as SIM card, or otherwise indicating the phone number on the 5G card.

In a similar way, the other LED tiles, such as 130, 135 and 140 each receive different parts of chunks of data addressed to those tiles. Of course, in a practical system, there can be many more such tiles. Because the data is sent wirelessly to an addressed tile, the LED tiles require a wired power connection, but no other wired connections.

This facilitates, therefore, pre-configuring an LED wall by providing power buses but no wired data connections. The LED wall is located in place. Then, a program can be used to instruct the video processor 100 about the addresses that comprise the different sections on the LED wall.

In one embodiment, the video processor can include a camera, and each LED tile can display its address. The camera can automatically translate the addresses displayed by the LED walls into their locations and store those as part of the address configuration unit 516, which can be part of, for example, a processor or a microcontroller. Other ways of automatically inserting the LED wall addresses can also be used. In another embodiment, the LED wall can display a QR code indicating its address, and the operator can manually scan the QR codes to add those into the proper locations.

In another embodiment, the addresses can be manually inserted into the video processor.

In one embodiment, a camera can automatically view the video walls, determine the location of the different video tiles, and read their addresses, and automatically configure the system to define which video wall has which address.

The video processor divides the video into the different chunks, and provides each chunk to one of the addresses specified in the address configuration file that it stores shown in 516. In this way, the video wall can be much more easily put together with any addressed portion in any random location, since the address configuration file stores the location and address of the wall. The video wall does not require cabling direct from the video processor, it can be freestanding other than the power connection.

Also, since 5G is extremely fast and low latency, the video processor can be located anywhere, including off-site. In one embodiment, the LED tiles can be pre-configured into walls at the off-site location, the video processor can be programmed, and then the LED tiles moved to the final location in the pre-configured or partially preconfigured form. The video processor can be operated from the remote location to control the content on the LED tiles at the stage.

Another embodiment is shown in FIG. 2. This uses a fast wireless communicator, e.g. 5G, retrofit card which is a set of electronics that can be installed internally or externally into legacy devices that do not have wireless communication capability. The legacy devices, such as 200, can be lighting devices, audio devices, video devices and scenery equipment. The retrofit card provides to provide those devices with 5G capabilities. FIG. 2 shows a legacy device 200, which is a luminaire. This device can be legacy controllable over its signal connector 205 via an existing “legacy” format such as DMX. The retrofit card according to embodiments is shown as 210, and itself has a connector 206 which connects to the connector 205 of the legacy device. For example if the legacy device is controllable over DMX, then the retrofit card can communicate using DMX format with the legacy device, providing data to the legacy device which can be sent and received over the 5G communication channel 211. This communication uses a data converter shown as 213. The data converter 213 converts the received data into the format required by the legacy device 200 and plugs into a connector 205 and the legacy device 200.

In different embodiments, the data converter can convert the data to DMX, Artnet, sACN, RDM, SDI, HDMI, Serial Data, Ethernet Data (Ethernet/IP), CAN bus, TwinCAT Dante, AVB or any other wired or wireless legacy format. In the embodiment, this format as a wired format

In embodiments, the data the retrofit card can also be bidirectional, so it can also receive signals back from the legacy device 200.

The embodiments show the antenna being external and the retrofit card being external, however this could be internal or external, and the retrofit card can also be connected to the first device using a wired daisy chain.

In embodiments, the retrofit card can use an external power source, for example it can piggyback off of the power source from the legacy device 200. It can also use an internal power source via batteries, making the retrofit card 210 operates like a cellular-like device, and can be formed as for example either a laptop or a tablet that connects via a wired connection into the legacy device. In another embodiment, the card can have its own power source.

In another embodiment, the legacy device can be a speaker system, and hence this can form a distributed speaker system using 5G cards.

This embodiment can also use augmented reality in a working environment rather than a creative environment. A machine vision product 225 is used to view the luminaire and its output to analyze for problems lighting rig in real time. The machine vision product can look for faults such as over temperature (by using IR detection), hardware failures (e.g., the lighting rig not doing the functions as commanded), and any other visually detectable problem.

This then provides the information over its 5G connection 226 to either an app or other similar system to enable that system to automatically monitor visual characteristics of the device, that are usually manually monitored by a technician. This can also be used for tech support for example, by directing the technicians to where machine vision device and see, point out, or assist getting the particular issue resolved.

The legacy device can also be modified or retrofitted to use fast internet, e.g., 5G devices, as startup items for different stage equipment. 5G allows a data signal to be used with a long battery life. In an embodiment, 5G chips 230 are included into a or retrofitted into device such as luminaire 200, which is normally stored in the unpowered mode. The lighting device includes a battery 231 that allows powering the 5G chips and certain control processes of the light, and is used to configure the equipment during preparation. The lighting device in operation is conventionally connected to power mains. However, the battery 231, for example which may be stored in a protected mode such as with a tab or switch preventing power dissipation from the battery. When the battery is connected, it wakes up control systems in the luminaire using the battery 231, to carry out certain functions in the luminaire but without turning on the light output of the luminaire. By sending a 5G signal using the 5G communicator 230, this can be used to turn on electronics within certain equipment during preparation and prior to hardwiring the equipment. This can be used for example to configure the equipment, carry out software updates, load content, for example onto media servers or video servers from any location, and track the devices.

The 5G devices can similarly be added to breakout boxes such as PRG's AS/400 breakout device, and used as a secondary data source.

5G devices can also be added to a GCFS truss box which converts a video signal to ethernet. The main backbone can be fiber, and can use 5G as an optional secondary source. This also has the advantage of enabling the information to be sent from any location, and not just from within the venue.

In a similar way, 5G can be used as a multi-viewer system for GCFS. 5G can be used as part of an SDI video converter.

In another embodiment, a live system can use discs which are local, but allow upload after data is recorded on the local disk. The data can be sent to an off-site control room for live mixing in programming, while the discs remain local to a different location.

An embodiment describes an intercom app used on a show site. In the intercom app, users can use an app on their 5G enabled phone to carry out communication with other users using a similar app.

Another embodiment uses a 5G private network with beacons dispersed at intervals over a venue. This creates a local positioning system for the tracking of objects, people and scenery. Each object person or scenery have a powered 5G device. The device is tracked using atmospherics with the 5G device, thereby tracking the location of the object on the stage.

Another application of using these 5G devices is replacement of typical RF systems for use in audience auditory assist devices. A system can receive certain auditory sounds, transmit them via 5G, and allow users to receive them on their personal cell phone using an app or other wireless communication system.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An LED wall, comprising:
multiple different LED tiles, arranged in an array,
each tile having an individual address,
each tile and having a fast wireless communicator,
and each tile having a processing system, the processing system causing said each tile to indicate its address during a configuration operation,
and the processing system causing the tile to subsequently to receiving its address during the duration operation, receiving and displaying a portion of an image, where the processing systems of each of the different multiple different LED tiles because the array to display an entirety of the image.

2. The LED wall as in claim 1, wherein the configuration system causes the address to be indicated during initial startup of the system.

3. The LED wall as in claim 1, wherein the address is indicated by displaying the address on the tile.

4. The LED wall as in claim 1, wherein the fast wireless communicator is a 5G cellular communicator.

5. The LED wall as in claim 1, further comprising a video processor, storing a file defining address configurations including addresses of each of the tiles in the array indicating where said each tile in the array is located in the array.

6. The LED wall as in claim 5, wherein the video processor divides the video into areas, and sends each of the areas to one of the LED tiles based on the addresses.

7. The LED wall as in claim 1, where each of the LED tiles has a wired power connection, and receives only wireless data, and does not have a wired data connection.

8. The LED wall as in claim 1, wherein the wireless communicator is a cellular communicator, and the address is based on the phone number of the cellular communicator.

9. The LED wall as in claim 3, wherein the address is displayed as a scannable code.

10. The LED wall as in claim 3, wherein the address is displayed as a QR code.

11. The LED wall as in claim 3, wherein the address is displayed as an alphanumeric address.
